(19) United States
(12) Patent Application Publication
(10) Pub. No.: US 2024/0319721 A1
(43) Pub. Date: Sep. 26, 2024

(54) Molding Management System

(71) Applicant: SEIKO EPSON CORPORATION, Tokyo (JP)

(72) Inventors: Kosuke ATSUTA, Shiojiri (JP); Soji SHIOZAWA, Matsumoto (JP)

(21) Appl. No.: 18/613,657

(22) Filed: Mar. 22, 2024

(30) Foreign Application Priority Data
Mar. 24, 2023 (JP) 2023-048315

(51) Int. Cl. G05B 19/418

(52) U.S. Cl. CPC G05B 19/41875; G05B 2219/32222

(57) ABSTRACT

A molding management system includes: a molded article item storage unit configured to store a plurality of pieces of molded article item information that are identification information of an item of a molded article; a defect classification storage unit configured to store master data including a plurality of pieces of defect classification information that are information related to classification of a defect of the molded article; a first receiving unit configured to receive selection of the molded article item information stored in the molded article item storage unit; a second receiving unit configured to receive selection of the defect classification information provided in the master data; an item defect storage unit configured to store the molded article item information received by the first receiving unit and the defect classification information received by the second receiving unit in association with each other; and a third receiving unit configured to receive, when the defect occurs in the molded article, selection of the defect classification information stored in the item defect storage unit in association with the molded article item information of an item of the molded article in which the defect occurs.

The present application is based on, and claims priority from JP Application Serial Number 2023-048315, filed Mar. 24, 2023, the disclosure of which is hereby incorporated by reference herein in its entirety.

### BACKGROUND

### 1. Technical Field

The present disclosure relates to a molding management system.

### 2. Related Art

In a program and an information processing device disclosed in JP-A-2019-119172, tag data in which a shot number is associated with a non-defective tag indicating that a molded article is a non-defective article or a defective tag indicating that a molded article is a defective article is stored in a storage device in association with temperature data, pressure data, and flow velocity data in a metal mold. The tag data described above is data input by a user using an input interface such as a keyboard.

JP-A-2019-119172 is an example of the related art.

### SUMMARY

In a case where a defect occurs in production of a molded article, a user may store an item of the molded article in which the defect occurs and detailed information of the defect in association with each other in a molding management system. In this case, when the user inputs detailed information about a defect using a keyboard or the like, there is a problem that it takes time to input the information.

According to a first aspect of the present disclosure, a molding management system is provided. The molding management system includes: a molded article item storage unit configured to store a plurality of pieces of molded article item information that are identification information of an item of a molded article; a defect classification storage unit configured to store master data including a plurality of pieces of defect classification information that are information related to classification of a defect of the molded article; a first receiving unit configured to receive selection of the molded article item information stored in the molded article item storage unit; a second receiving unit configured to receive selection of the defect classification information provided in the master data; an item defect storage unit configured to store the molded article item information received by the first receiving unit and the defect classification information received by the second receiving unit in association with each other; and a third receiving unit configured to receive, when the defect occurs in the molded article, selection of the defect classification information stored in the item defect storage unit in association with the molded article item information of an item of the molded article in which the defect occurs.

### BRIEF DESCRIPTION OF THE DRAWINGS

FIG. 1 is a diagram illustrating a schematic configuration of a molding management system.

FIG. 2 is a flowchart illustrating defect classification association processing performed by the molding management system.

FIG. 3 is a view illustrating a molded article item list screen.

FIG. 4 is a view illustrating a defect classification association screen.

FIG. 5 is a flowchart illustrating defect input processing.

FIG. 6 is a view illustrating an inspection screen.

FIG. 7 is a view illustrating a defect input screen.

FIG. 8 is a diagram illustrating a schematic configuration of a molding management system according to a second embodiment.

FIG. 9 is a flowchart illustrating defect classification association processing according to the second embodiment.

FIG. 10 is a view illustrating a production process list screen.

FIG. 11 is a view illustrating a process defect classification association screen.

FIG. 12 is a view illustrating a molded article item process association screen.

### DESCRIPTION OF EMBODIMENTS

### A: First Embodiment

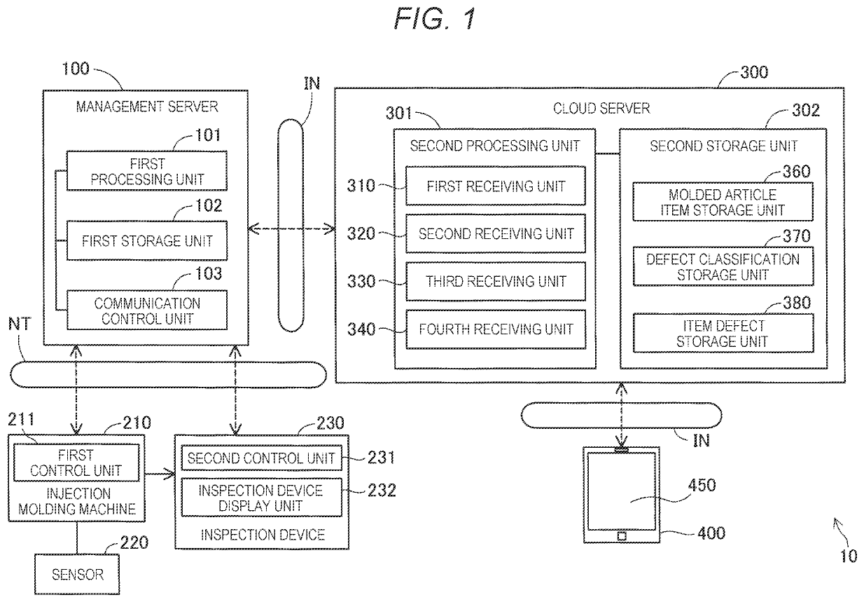

FIG. 1 is a diagram illustrating a schematic configuration of a molding management system 10. The molding management system 10 includes a management server 100, an injection molding machine 210, a sensor 220, an inspection device 230, a cloud server 300, and a terminal device 400. The management server 100 is configured to communicate with the injection molding machine 210 and the inspection device 230 via a network NT. The network NT may be, for example, a LAN, a WAN, or an Internet. The sensor 220 is coupled to the injection molding machine 210. The cloud server 300 is configured to communicate with the management server 100 and the terminal device 400 via an Internet IN. Although FIG. 1 illustrates an example in which the molding management system: 10 includes one injection molding machine 210, one sensor 220, and one inspection device 230, the molding management system 10 may include a plurality of injection molding machines 210, a plurality of sensors 220, and a plurality of inspection devices 230. In addition to the inspection device 230, the molding management system 10 may include a peripheral machine such as an extraction robot that extracts a molded article from the injection molding machine 210 and a dryer that dries a material used in the injection molding machine 210.

The injection molding machine 210 is a device that performs injection molding. The injection molding machine 210 includes a first control unit 211, an injection device (not illustrated), and a mold clamping device (not illustrated). A mold having a cavity is attached to the mold clamping device. The mold may be made of a metal, ceramic, or a resin. A mold made of a metal is referred to as a metal mold. The first control unit 211 is implemented by a computer including one or more processors, a storage device, and an input and output interface that inputs a signal from and outputs a signal to the outside. The first control unit 211 may be implemented by a plurality of computers. The injection molding machine 210 may include a display device such as a liquid crystal display and an input device such as a keyboard.

The first control unit 211 performs injection molding by controlling units of the injection molding machine 210 based on molding conditions acquired from the cloud server 300 via the management server 100, and molds a molded article. More specifically, the first control unit 211 controls the mold clamping device to clamp the mold, and controls the injection device to inject a shaping material obtained by plasticizing a material into the mold, thereby molding a molded article having a shape corresponding to a shape of the cavity formed in the mold.

The sensor 220 measures injection pressure, a temperature of the metal mold, an injection filling time, and the like that are physical quantities related to an operation state of the injection molding machine 210. The sensor 220 is, for example, a pressure sensor that measures injection pressure or a temperature sensor that measures a temperature of the metal mold. The sensor 220 transmits a measured physical quantity related to an operation state of the injection molding machine 210 to the management server 100 via the first control unit 211 of the injection molding machine 210. The sensor 220 may be configured to communicate with the management server 100 via the network NT. In this case, the sensor 220 may transmit a measured physical quantity related to an operation state of the injection molding machine 210 to the management server 100 without passing through the first control unit 211.

The inspection device 230 is a device that inspects a molded article. The inspection device 230 includes a second control unit 231, an inspection device display unit 232, and a camera (not illustrated). The inspection device display unit 232 is implemented by a liquid crystal display or the like. The inspection device display unit 232 may have a touch panel function. The inspection device 230 may include an input device such as a keyboard. The second control unit 231 controls the camera to capture an image of a molded article, and displays the captured image of the molded article on the inspection device display unit 232. The second control unit 231 may transmit the captured image of the molded article to the management server 100.

The management server 100 is implemented by a computer including a first processing unit 101, a first storage unit 102, and a communication control unit 103. The first processing unit 101 includes one or more processors and a main storage device. The first storage unit 102 is implemented by an auxiliary storage device such as a hard disk drive. The communication control unit 103 includes a communication circuit for controlling communication with another device such as the cloud server 300 and the injection molding machine 210. The management server 100 may be implemented by a plurality of computers. The management server 100 may include a display device such as a liquid crystal display and an input device such as a keyboard and a mouse.

The first processing unit 101 acquires a physical quantity related to an operation state of the injection molding machine 210 transmitted from the sensor 220. The physical quantity related to an operation state of the injection molding machine 210 acquired by the first processing unit 101 is stored in the first storage unit 102. The first processing unit 101 may transmit the physical quantity related to an operation state of the injection molding machine 210 to the cloud server 300. In this case, the physical quantity related to an operation state of the injection molding machine 210 is stored in a second storage unit 302 of the cloud server 300.

The terminal device 400 is implemented as a computer including a CPU, a storage device, and a display unit 450. Examples of the terminal device 400 include a tablet terminal, a notebook computer, a smartphone, or a handy terminal. The display unit 450 displays various screens output from the cloud server 300. The display unit 450 may have a touch panel function. The terminal device 400 is also referred to as an information terminal.

The cloud server 300 is a server used via an Internet IN. The cloud server 300 includes a second processing unit 301 and the second storage unit 302. The first storage unit 102 of the management server 100 and the second storage unit 302 of the cloud server 300 are also collectively referred to as a storage unit. The management server 100 and the cloud server 300 may be implemented as one server.

The second storage unit 302 includes a molded article item storage unit 360, a defect classification storage unit 370, and an item defect storage unit 380. The molded article item storage unit 360 stores a plurality of pieces of molded article item information that are identification information of items of a molded article. The molded article item information is identification information assigned to an item of each molded article. The molded article item information includes a name of an item of each molded article, an ID number assigned to the item of each molded article, or the like. Hereinafter, an item of a molded article is also referred to as a molded article item.

The molded article item storage unit 360 stores molded article type information that is information related to a type of a molded article. The molded article type information includes an optical component, an insert component, and a multicolor molded component. Here, the optical component is a molded article including a transparent portion. The insert component is a molded article molded by insert molding of a molded article in which an insert article and a resin are integrated. The multicolor molded component is a molded article by multicolor molding of a molded article in which resins of different colors and materials are integrated. The molded article type information may include any one of the optical component, the insert component, and the multicolor molded component. The molded article type information may include a spherical component, a plate-shaped component, or the like.

The defect classification storage unit 370 stores master data including a plurality of pieces of defect classification information that are information related to classification of defects of a molded article. The master data includes defect classification information of a defect specific to each type of molded article. The defect classification information includes damage, a burr, a weld line, a flow mark, insufficient filling, chipping and cracking, falling, a dimensional defect, stain, bending, discoloration, burning, an inspection error, a bubble, yellowing, an insert article defect, an insert article insertion error, insufficient filling (a first color), insufficient filling (a second color), and deterioration. Here, the insufficient filling refers to that a cavity is not sufficiently filled with a shaping material when the shaping material is injected into the mold. The insert article defect refers to that a defect occurs in a molded article due to a defect in an insert article in an insert molding process. The insert article insertion error refers to that there is a problem in attaching an insert article to a mold in the insert molding process. The insufficient filling (a first color) refers to that a cavity is not sufficiently filled with a shaping material of the first color in a multicolor molding process. The insufficient filling (a second color) refers to that a cavity is not sufficiently filled with a shaping material of the second color which is a color different from the first color in the multicolor molding process.

Among the defect classification information described above, the bubble and the yellowing are defect classification information specific to the optical component. The insert article defect and the insert article insertion error are defect classification information specific to the insert component. The insufficient filling (a first color) and the insufficient filling (a second color) are defect classification information specific to the multicolor molded component.

The molded article item information and the defect classification information are stored in the item defect storage unit 380 in association with each other.

The second processing unit 301 of the cloud server 300 includes a first receiving unit 310, a second receiving unit 320, a third receiving unit 330, and a fourth receiving unit 340. The first receiving unit 310, the second receiving unit 320, the third receiving unit 330, and the fourth receiving unit 340 are implemented by the second processing unit 301 executing a program stored in the second storage unit 302. These receiving units may be implemented by circuits.

The first receiving unit 310 receives selection of the molded article item information stored in the molded article item storage unit 360.

The second receiving unit 320 receives selection of the defect classification information provided in the master data stored in the defect classification storage unit 370.

When a defect occurs in a molded article, the third receiving unit 330 receives selection of the defect classification information.

The fourth receiving unit 340 receives selection of the molded article type information stored in the molded article item storage unit 360.

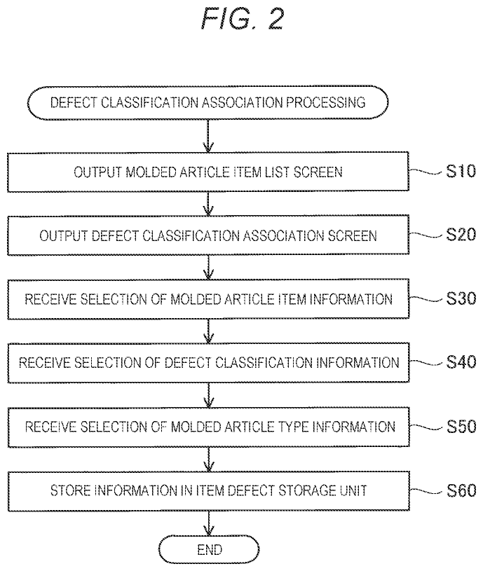

FIG. 2 is a flowchart illustrating defect classification association processing performed by the molding management system 10. The defect classification association processing is performed when a predetermined operation is performed on the molding management system 10.

In step S10, the second processing unit 301 of the cloud server 300 generates data of a molded article item list screen SC1 on which the molded article item information stored in the molded article item storage unit 360 is displayed, and outputs the data to the terminal device 400. The molded article item list screen SC1 is displayed on the display unit 450 of the terminal device 400.

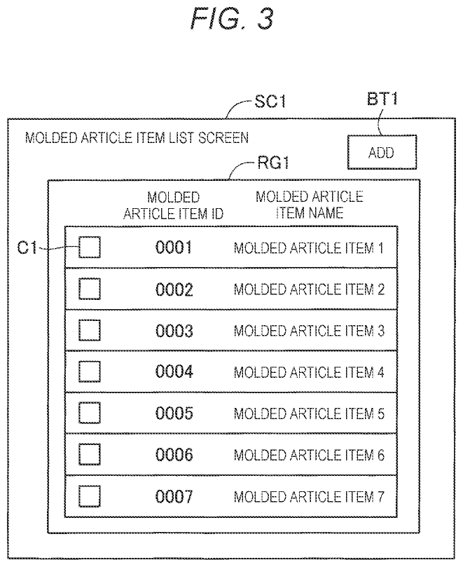

FIG. 3 is a view illustrating the molded article item list screen SC1. The molded article item list screen SC1 includes a molded article item display region RG1 and an add button BT1. A molded article item ID serving as molded article item information and a molded article item name serving as molded article item information are displayed for each molded article item in the molded article item display region RG1. In addition, a check box C1 associated with each molded article item is provided in the molded article item display region RG1.

In step S20 illustrated in FIG. 2, the second processing unit 301 of the cloud server 300 generates data of a defect classification association screen SC2 that is a screen for enabling a user to select defect classification information associated with a molded article item, and outputs the data to the terminal device 400. The defect classification association screen SC2 is displayed on the display unit 450 of the terminal device 400. The step S20 is performed when the add button BT1 is clicked on the molded article item list screen SC1 illustrated in FIG. 3.

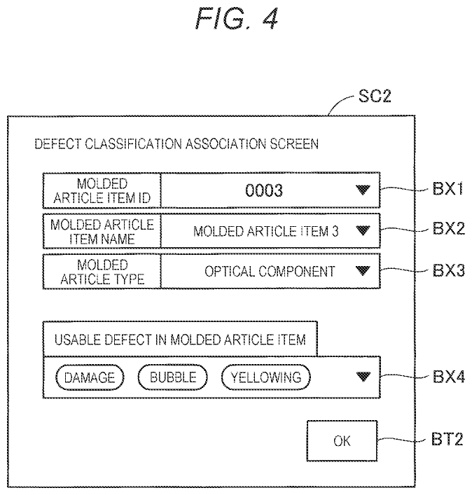

FIG. 4 is a view illustrating the defect classification association screen SC2. The defect classification association screen SC2 includes a selection field BX1, a selection field BX2, a selection field BX3, a selection field BX4, and an OK button BT2. A molded article item ID is selected in the selection field BX1. The selection field BX1 is configured to display a list of molded article item IDs stored in the molded article item storage unit 360 when the user clicks the selection field BX1. A molded article item name is selected in the selection field BX2. The selection field BX2 is configured to display a list of molded article item names stored in the molded article item storage unit 360 when the user clicks the selection field BX2. Molded article type information is selected in the selection field BX3. The selection field BX3 is configured to display a list of molded article type information stored in the molded article item storage unit 360 when the user clicks the selection field BX3. Defect classification information is selected in the selection field BX4. The selection field BX4 is configured to display a list of defect classification information provided in the master data stored in the defect classification storage unit 370 when the user clicks the selection field BX4.

The user selects information on the defect classification association screen SC2. Hereinafter, the information selected by the user on the defect classification association screen SC2 will be described. The user selects a molded article item ID of a molded article item associated with defect classification information in the selection field BX1 or a molded article item name of a molded article item associated with defect classification information in the selection field BX2. In the selection field BX3, the user selects molded article type information of a molded article item corresponding to the molded article item information selected in the selection field BX1 or the selection field BX2. For example, when the molded article item information of a molded article including a transparent portion is selected in the selection field BX1 or the selection field BX2, the user selects “optical component” in the selection field BX3. The user may select a plurality of pieces of molded article type information in the selection field BX3. For example, when the molded article item information of a molded article including a transparent portion and an insert article is selected in the selection field BX1 or the selection field BX2, the user selects “optical component” and “insert component” in the selection field BX3. In the selection field BX4, the user selects defect classification information associated with a molded article item corresponding to the molded article item information selected in the selection field BX1 or the selection field BX2. Information selected by the user in each selection field is displayed in the selection field BX1 to the selection field BX4.

In the selection field BX4, the user selects defect classification information indicating that a defect may occur in the molded article item selected in the selection field BX1 or the selection field BX2. In other words, in the selection field BX4, the user selects defect classification information of a defect specific to the molded article item selected in the selection field BX1 or the selection field BX2. Hereinafter, an example of the defect classification information selected in the selection field BX4 by the user for each molded article item will be described.

When the molded article item is an optical component, the user selects defect classification information such as a bubble, yellowing, damage, and a burr. When the molded article item is an insert component, the user selects defect classification information such as an insert article defect, an insert article insertion error, damage, and a burr. When the molded article item is a multicolor molded component, the user selects defect classification information such as insufficient filling (a first color), insufficient filling (a second color), damage, and a burr. When the molded article item is not an optical component, the user does not select defect classification information such as a bubble and yellowing. When the molded article item is not an insert component, the user does not select defect classification information such as an insert article defect and an insert article insertion error. When the molded article item is not a multicolor molded component, the user does not select defect classification information such as insufficient filling (a first color) and insufficient filling (a second color).

In step S30 illustrated in FIG. 2, the first receiving unit 310 receives the molded article item ID selected in the selection field BX1 on the defect classification association screen SC2 illustrated in FIG. 4 or the molded article item name selected in the selection field BX2 as molded article item information. The step S30 and subsequent steps are performed when the OK button BT2 on the defect classification association screen SC2 is clicked.

In step S40 illustrated in FIG. 2, the second receiving unit 320 receives the defect classification information selected in the selection field BX4 on the defect classification association screen SC2 illustrated in FIG. 4.

In step S50 illustrated in FIG. 2, the fourth receiving unit 340 receives the molded article type information selected in the selection field BX3 on the defect classification association screen SC2 illustrated in FIG. 4.

In step S60, the second processing unit 301 of the cloud server 300 stores, in the item defect storage unit 380, the molded article item information received by the first receiving unit 310 in step S30, the defect classification information received by the second receiving unit 320 in step S40, and the molded article type information received by the fourth receiving unit 340 in step S50 in association with one another. The defect classification association processing is performed as described above.

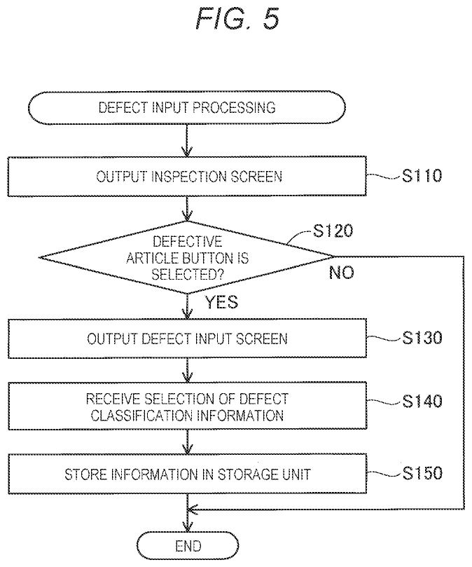

FIG. 5 is a flowchart illustrating defect input processing performed by the molding management system 10. The defect input processing is performed when the inspection device 230 inspects a molded article.

In step S110, the second control unit 231 of the inspection device 230 outputs an inspection screen SC3 to the inspection device display unit 232. The inspection screen SC3 is displayed on the inspection device display unit 232. The second control unit 231 may output the inspection screen SC3 to the management server 100. In this case, the management server 100 displays the inspection screen SC3 on the display unit 450 of the terminal device 400 via the cloud server 300.

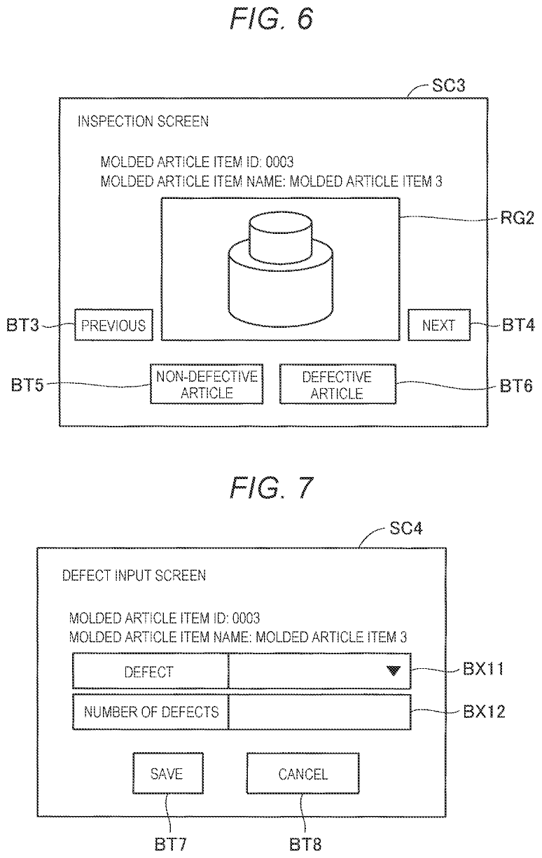

FIG. 6 is a view illustrating the inspection screen SC3. The inspection screen SC3 includes an image display region RG2, a previous image display button BT3, a next image display button BT4, a non-defective article button BT5, and a defective article button BT6. An image of a molded article captured by the camera of the inspection device 230 is displayed in the image display region RG2. The inspection screen SC3 displays molded article item information of the molded article displayed in the image display region RG2. The previous image display button BT3 and the next image display button BT4 are configured to change an image displayed in the image display region RG2 to an image of another molded article having the same molded article item information when the user clicks the previous image display button BT3 and the next image display button BT4. The user checks images of all molded articles having the same molded article item information on the inspection screen SC3, and clicks the non-defective article button BT5 when there is no defect in all of the molded articles, and clicks the defective article button BT6 when there is a defect in at least one molded article.

In step S120 illustrated in FIG. 5, the second control unit 231 determines whether the defective article button BT6 is selected on the inspection screen SC3. When the non-defective article button BT5 is selected, the second control unit 231 ends the defect input processing. When the defective article button BT6 is selected, the second control unit 231 performs step S130.

In step S130, the inspection device 230 outputs a defect input screen SC4 that is a screen for enabling the user to select defect classification information to the inspection device display unit 232. The defect input screen SC4 is displayed on the inspection device display unit 232. The second control unit 231 may output the defect input screen SC4 to the management server 100. In this case, the management server 100 displays the defect input screen SC4 on the display unit 450 of the terminal device 400 via the cloud server 300.

FIG. 7 is a view illustrating the defect input screen SC4. The defect input screen SC4 includes a selection field BX11, an input field BX12, a save button BT7, and a cancel button BT8. The molded article item information of the molded article displayed on the inspection screen SC3 is displayed on the defect input screen SC4. Defect classification information is selected in the selection field BX11. The selection field BX11 is configured to display a list of defect classification information stored in the item defect storage unit 380 in association with the molded article item information displayed on the defect input screen SC4 when the user clicks the selection field BX11. The number of molded articles in which a defect occurs is input to the input field BX12.

The user inputs information on the defect input screen SC4. In the selection field BX11, the user selects defect classification information corresponding to a defect occurring in a molded article having the molded article item information displayed on the defect input screen SC4. The user inputs the number of molded articles in which a defect occurs to the input field BX12.

Hereinafter, an example of information selected by the user in the selection field BX11 on the defect input screen SC4 when a defect occurs in a molded article will be described. For example, when it is confirmed that a bubble occurs in a molded article that is an optical component, the user selects defect classification information of “bubble” in the selection field BX11. When it is confirmed that a defect occurs in an insert article of a molded article that is an insert component, the user selects defect classification information of “insert article defect” in the selection field BX11. When it is confirmed that filling with a shaping material of a first color is insufficient in a molded article that is a multicolor molded component, the user selects defect classification information of “insufficient filling (a first color)” in the selection field BX11.

In step S140 illustrated in FIG. 5, the third receiving unit 330 receives the defect classification information selected in the selection field BX11 on the defect input screen SC4 illustrated in FIG. 7. That is, when a defect occurs in a molded article, the third receiving unit 330 receives selection of defect classification information stored in the item defect storage unit 380 in association with molded article item information of an item of the molded article in which the defect occurs. In step S140, the second processing unit 301 receives information input to the input field BX12. The step S140 is performed when the save button BT7 on the defect input screen SC4 is clicked.

In step S150 illustrated in FIG. 5, the second processing unit 301 stores, in the second storage unit 302, the defect classification information received by the third receiving unit 330 in step S140, the molded article item information displayed on the defect input screen SC4, and the information input to the input field BX12 in association with one another. The second processing unit 301 may store the above-described information in the first storage unit 102 of the management server 100 in association with one another. That is, the second processing unit 301 stores molded article item information of a molded article in which a defect occurs, defect classification information, and the number of molded articles in which a defect occurs in a storage unit in association with one another. The defect input processing is performed as described above.

According to the molding management system 10 in the first embodiment described above, molded article item information selected from the molded article item information stored in the molded article item storage unit 360 and defect classification information selected from the defect classification information provided in the master data stored in the defect classification storage unit 370 are stored in the item defect storage unit 380 in association with each other. When a defect occurs in a molded article, the third receiving unit 330 receives selection of defect classification information stored in the item defect storage unit 380 in association with molded article item information of the molded article in which the defect occurs. Therefore, when a defect occurs in a molded article, the can user select defect classification information stored in the item defect storage unit 380 in association with molded article item information of the molded article in which the defect occurs. Accordingly, it is not necessary to input detailed information of the occurred defect using a keyboard or the like, and thus it is possible to shorten a time taken to input the detailed information of the defect.

In the embodiment, in the defect classification association processing illustrated in FIG. 2, the user can store only defect classification information of a defect specific to each molded article item in the item defect storage unit 380 in association with molded article item information of a molded article item. Therefore, only defect classification information of a defect specific to a molded article item in which the defect occurs is displayed in the selection field BX11 on the defect input screen SC4 illustrated in FIG. 7. For example, when molded article item information of an optical component is displayed on the defect input screen SC4, only defect classification information of a defect specific to the optical component is displayed in the selection field BX11. Therefore, the user can easily select defect classification information of an occurred defect in the defect input processing.

In the embodiment, molded article item information, defect classification information, and the number of molded articles in which a defect occurs are stored in the second storage unit 302 in association with one another in the defect input processing illustrated in FIG. 5. Therefore, the second storage unit 302 stores the number of molded articles in which a defect of specific defect classification information occurs. Accordingly, the number of molded articles in which defect of specific defect classification information occurs can be accurately counted.

In the embodiment, the defect classification storage unit 370 stores the master data including a plurality of pieces of defect classification information. The master data includes defect classification information specific to each molded article item for all molded article items. Therefore, the user can edit defect classification information of all molded article items by editing one piece of master data. Accordingly, the master data of defect classification information can be easily managed as compared with a case where the master data including defect classification information specific to each molded article item is stored for each molded article item in the defect classification storage unit 370.

### B. Second Embodiment

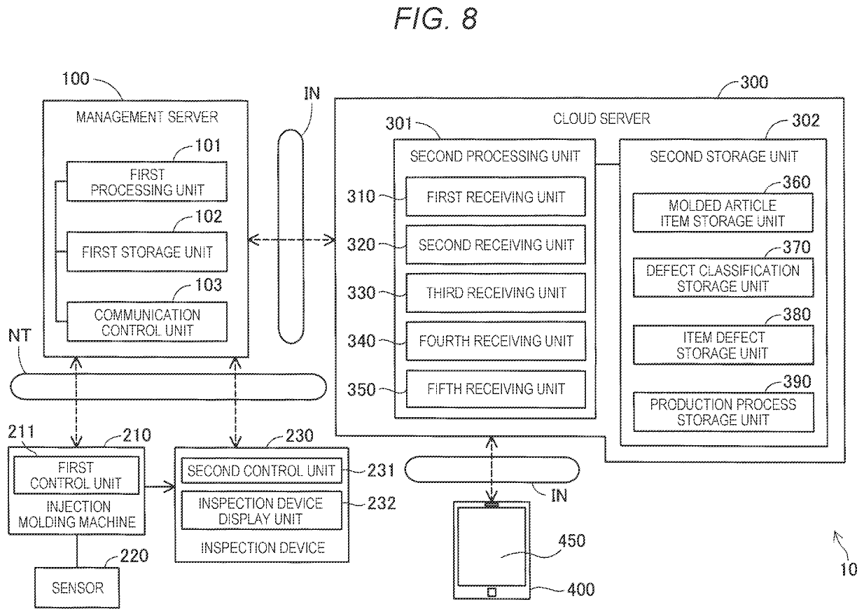

FIG. 8 is a diagram illustrating a schematic configuration of the molding management system 10 according to a second embodiment. In the second embodiment, the second processing unit 301 of the cloud server 300 further includes a fifth receiving unit 350. The second storage unit 302 of the cloud server 300 further includes a production process storage unit 390. The configuration of each unit of the molding management system 10 other than the cloud server 300 is the same as that in the first embodiment.

The production process storage unit 390 stores a plurality of pieces of production process information that are identification information of production processes of a molded article. The production processes of a molded article include a drying process, a press process, a molding process, an optical component molding process, an insert molding process, a multicolor molding process, a conveying process, an appearance inspection process, a deburring process, a cleaning process, a shipping inspection process, a shipping approval process, a packaging process, and a finished inventory process. The production process information is identification information assigned to each production process. The production process information is a name of a production process, an ID number assigned to each production process, or the like.

Hereinafter, the production processes described above will be described in detail. The drying process is a process of drying a material used for molding a molded article. The press process is a process of producing an insert article used in the insert molding process. The molding process is a process in which a molded article is molded by the injection molding machine 210. The optical component molding process is a process in which a molded article that is an optical component is molded by the injection molding machine 210. The insert molding process is a process in which a molded article that is an insert component is molded by the injection molding machine 210. The insert molding process is performed by the injection molding machine 210 that can perform insert molding. The multicolor molding process is a process in which a molded article that is a multicolor molded component is molded by the injection molding machine 210. The multicolor molding process is performed by the injection molding machine 210 that can perform multicolor molding. Molding of an optical component, insert molding, or multicolor molding is not performed in the molding process. The conveying process is a process of conveying a material or a molded article between the injection molding machine 210 and a peripheral machine. The appearance inspection process is a process in which a molded article is inspected by the inspection device 230 immediately after the molded article is molded by the injection molding machine 210. The deburring process is a process of removing a burr from the molded article. The cleaning process is a process of cleaning a molded article. The shipping inspection process is a process in which the molded article is inspected by the inspection device 230 before the molded article is shipped. The shipping approval process is a process in which there is no problem in quality of the molded article and shipping is approved by a factory manager. The packaging process is a process of packaging the molded article. An operation of putting the molded article into a storage container without packaging the molded article or an operation of putting the molded article on a storage tray without packaging the molded article is also provided in the packaging process. The finished inventory process is a production process performed after the packaging process. In the finished inventory process, the molded article is stored in an inventory or the like in a state where the molded article can be shipped.

The fifth receiving unit 350 receives selection of production process information stored in the production process storage unit 390.

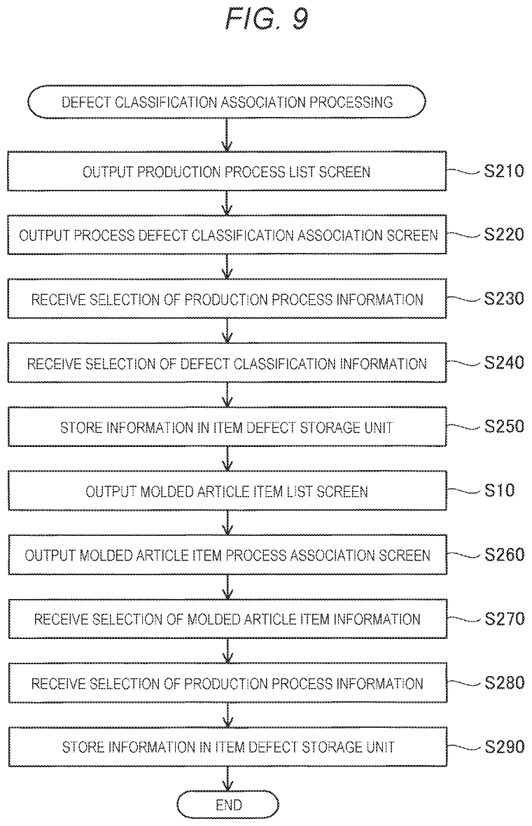

FIG. 9 is a flowchart illustrating defect classification association processing according to the second embodiment. The same reference numeral is given to a portion where processing the same as the defect classification association processing in the first embodiment illustrated in FIG. 2 is performed, and description thereof will be omitted.

In step S210, the second processing unit 301 of the cloud server 300 generates data of a production process list screen SC5 on which production process information stored in the production process storage unit 390 is displayed, and outputs the data to the terminal device 400. The production process list screen SC5 is displayed on the display unit 450 of the terminal device 400.

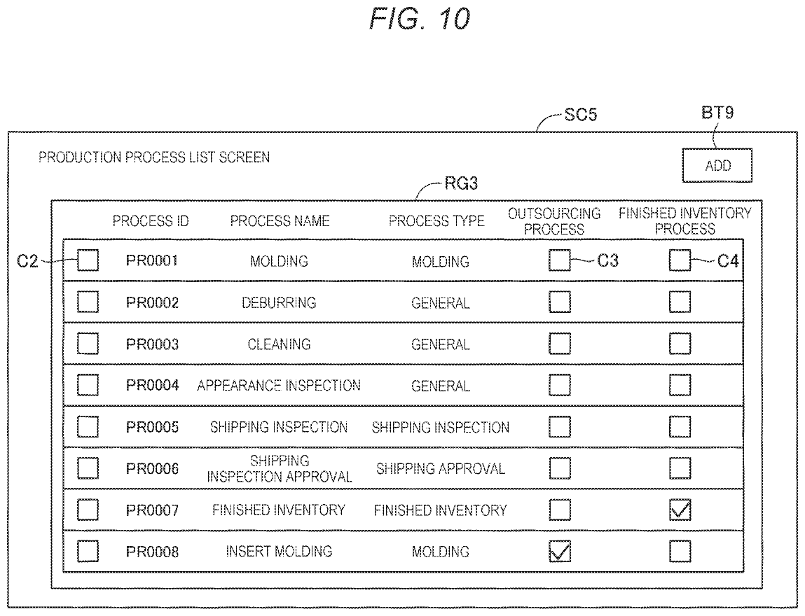

FIG. 10 is a view illustrating the production process list screen SC5. The production process list screen SC5 includes a production process display region RG3 and an add button BT9.

A process ID serving as production process information, a process name serving as production process information, and a process type are displayed in the production process display region RG3 for each production process. A check box C3 indicating whether a production process is the outsourcing process and a check box C4 indicating whether a production process is the finished inventory process are displayed in the production process display region RG3 for each production process. In addition, a check box C2 associated with each production process is provided in the production process display region RG3.

The process type is information related to a type of a production process. There are five process types including molding, general, shipping inspection, shipping approval, and finished inventory. A production process is classified into any one of the process types. The production process whose process type is molding is a process of molding a molded article such as the molding process, the optical component molding process, the insert molding process, and the multicolor molding process. A production process whose process type is general is a process excluding the process of molding a molded article among processes of manufacturing a molded article, such as the deburring process, the cleaning process, and the appearance inspection process. A production process whose process type is shipping inspection is the shipping inspection process. A production process whose process type is shipping approval is the shipping approval process. A production process whose process type is finished inventory is the finished inventory process. The production process information and the process type are stored in the production process storage unit 390 in association with each other in advance. The number of process types may not be five as described above. The production process display region RG3 may not display the process type.

The outsourcing process is a production process performed in a factory other than a factory having the injection molding machine 210 or the peripheral machine provided in the molding management system 10. Hereinafter, the factory having the injection molding machine 210 or the peripheral machine provided in the molding management system 10 is also referred to as a factory of an own company, and a factory other than the factory of the own company is also referred to as a factory of another company. That is, the outsourcing process is a production process performed in a factory of another company. For example, when an insert molding process is performed by an injection molding machine provided in a factory of another company, the insert molding process is an outsourcing process. When a production process is an outsourcing process, the check box C3 is checked. When a production process is the finished inventory process, the check box C4 is checked.

In step S220 illustrated in FIG. 9, the second processing unit 301 of the cloud server 300 generates data of a process defect classification association screen SC6 that is a screen for enabling a user to select defect classification information associated with a production process, and outputs the data to the terminal device 400. The process defect classification association screen SC6 is displayed on the display unit 450 of the terminal device 400. The step S220 is performed when the add button BT9 is clicked on the production process list screen SC5 illustrated in FIG. 10.

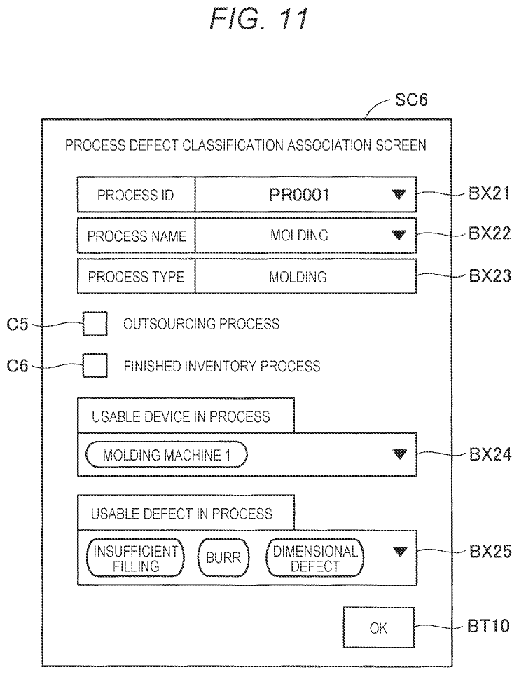

FIG. 11 is a view illustrating the process defect classification association screen SC6. The process defect classification association screen SC6 includes a selection field BX21, a selection field BX22, a display field BX23, a check box C5, a check box C6, a selection field BX24, a selection field BX25, and an OK button BT10. A process ID is selected in the selection field BX21. The selection field BX21 is configured to display a list of process IDs stored in the production process storage unit 390 when the user clicks the selection field BX21. A process name is selected in the selection field BX22. The selection field BX22 is configured to display a list of process names stored in the production process storage unit 390 when the user clicks the selection field BX22. A process type is displayed in the display field BX23. Information indicating whether a production process is an outsourcing process is selected in the check box C5. Information indicating whether a production process is a finished inventory process is selected in the check box C6. The injection molding machine 210 or the peripheral machine provided in the molding management system 10 is selected in the selection field BX24. The selection field BX24 is configured to display a list of the injection molding machine 210 and the peripheral machine provided in the molding management system 10 when the user clicks the selection field BX24. Defect classification information is selected in the selection field BX25. The selection field BX25 is configured to display a list of defect classification information provided in the master data stored in the defect classification storage unit 370 when the user clicks the selection field BX25.

The user inputs information to the process defect classification association screen SC6. Hereinafter, information input to the process defect classification association screen SC6 by the user will be described.

The user selects a process ID of a production process associated with defect classification information in the selection field BX21, or a process name of a production process associated with defect classification information in the selection field BX22. A process type stored in the production process storage unit 390 in association with the process ID selected in the selection field BX21 or the process name selected in the selection field BX22 is displayed in the display field BX23.

When a production process selected in the selection field BX21 or the selection field BX22 is the outsourcing process, the user checks the check box C5. When the production process selected in the selection field BX21 or the selection field BX22 is performed in a factory of another company, the user checks the check box C5. For example, when the molding management system 10 does not include the injection molding machine 210 that can perform insert molding or the injection molding machine 210 that can perform multicolor molding, the user sets an insert molding process and a multicolor molding process as outsourcing processes. In this case, the user selects the insert molding process or the multicolor molding process in the selection field BX21 or the selection field BX22, and checks the check box C5.

When the production process selected in the selection field BX21 or the selection field BX22 is the finished inventory process, the user checks the check box C6.

In the selection field BX24, the user selects the injection molding machine 210 or the peripheral machine used in the production process selected in the selection field BX21 or the selection field BX22. A name of the injection molding machine 210 or the peripheral machine selected by the user is displayed in the selection field BX24.

In the selection field BX25, the user selects defect classification information associated with the production process selected in the selection field BX21 or the selection field BX22. The defect classification information selected by the user is displayed in the selection field BX25.

In the selection field BX25, the user selects defect classification information indicating that a defect may occur in the production process selected in the selection field BX21 or the selection field BX22. Hereinafter, an example of the defect classification information selected by the user in the selection field BX25 for each production process will be described. When the production process is the drying process, the user selects defect classification information such as discoloration and burning. When the production process is the press process, the user selects defect classification information such as a burr, a dimensional defect, and bending. When the production process is the molding process, the user selects defect classification n information such as insufficient filling, a burr, and a dimensional defect. When the production process is the optical component molding process, the user selects defect classification information such as a bubble, yellowing, and a burr. When the production process is the insert molding process, the user selects defect classification information such as an insert article defect, an insert article insertion error, and insufficient filling. When the production process is the multicolor molding process, the user selects defect classification information such as insufficient filling (a first color), insufficient filling (a second color), and a burr. When the production process is the conveying process, the user selects defect classification information such as chipping and cracking, damage, and falling. When the production process is the appearance inspection process, the user selects defect classification information such as insufficient filling, damage, and a dimensional defect. When the production process is the deburring process, the user selects defect classification information such as chipping and cracking, and damage. When the production process is the cleaning process, the user selects defect classification information such as stain, chipping and cracking, and damage. When the production process is the shipping inspection process, the user selects defect classification information such as insufficient filling, damage, and a dimensional defect. When the production process is the shipping approval process, the user selects defect classification information such as falling and an inspection error. When the production process is the packaging process, the user selects defect classification information such as falling, chipping and cracking, and damage. When the production process is the finished inventory process, the user selects defect classification information such as stain and deterioration.

In step S230 illustrated in FIG. 9, the fifth receiving unit 350 receives the process ID selected in the selection field BX21 on the process defect classification association screen SC6 illustrated in FIG. 11 or the process name selected in the selection field BX22 as production process information. The step S230 is performed when the OK button BT10 on the process defect classification association screen SC6 is clicked.

In step S240 illustrated in FIG. 9, the second receiving unit 320 receives the defect classification information selected in the selection field BX25 on the process defect classification association screen SC6 illustrated in FIG. 11.

In step S250 illustrated in FIG. 9, the second processing unit 301 of the cloud server 300 stores, in the item defect storage unit 380, the production process information received by the fifth receiving unit 350 in step S230 and the defect classification information received by the second receiving unit 320 in step S240 in the item defect storage unit 380 in association with each other.

In step S260, the second processing unit 301 of the cloud server 300 generates data of a molded article item process association screen SC7 that is a screen for enabling the user to select a production process associated with a molded article item, and outputs the data to the terminal device 400. The molded article item process association screen SC7 is displayed on the display unit 450 of the terminal device 400. The step S260 is performed when the add button BT1 on the molded article item list screen SC1 illustrated in FIG. 3 is clicked in step S10.

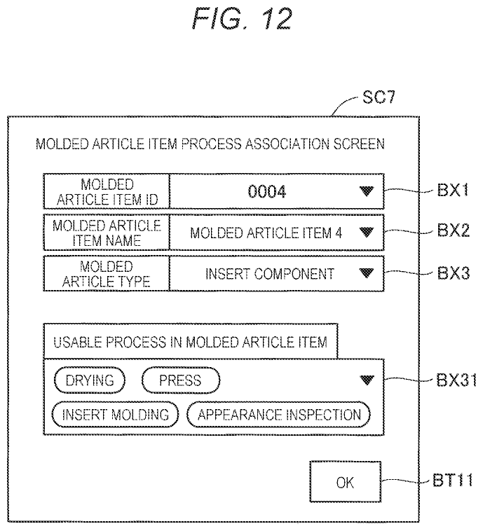

FIG. 12 is a view illustrating the molded article item process association screen SC7. The molded article item process association screen SC7 includes the selection field BX1, the selection field BX2, the selection field BX3, a selection field BX31, and an OK button BT11. The selection field BX1, the selection field BX2, and the selection field BX3 are provided in a similar manner to the selection field BX1, the selection field BX2, and the selection field BX3 on the defect classification association screen SC2 illustrated in FIG. 4. Production process information is selected in the selection field BX31. The selection field BX31 is configured to display a list of production process information stored in the production process storage unit 390 when the user clicks the selection field BX31.

The user selects information on the molded article item process association screen SC7. Hereinafter, information selected by the user on the molded article item process association screen SC7 will be described.

The user selects a molded article item ID of a molded article item associated with production process information in the selection field BX1 or a molded article item name of a molded article item associated with production process information in the selection field BX2. In the selection field BX3, the user selects molded article type information of a molded article item corresponding to the molded article item information selected in the selection field BX1 or the selection field BX2. In the selection field BX31, the user selects production process information associated with a molded article item corresponding to the molded article item information selected in the selection field BX1 or the selection field BX2. Information selected by the user in each selection field is displayed in the selection field BX1 to the selection field BX3, and the selection field BX31.

In the selection field BX31, the user selects a production process required for producing the molded article item selected in the selection field BX1 or the selection field BX2. For example, when the molded article item is an optical component, the user selects production process information including an optical component molding process and an appearance inspection process in the selection field BX31. When the molded article item is an insert component, the user selects production process information including a press process, an insert molding process, and an appearance inspection process in the selection field BX31. When the molded article item is a multicolor molded component, the user selects production process information including a multicolor molding process and an appearance inspection process in the selection field BX31.

In step S270 illustrated in FIG. 9, the first receiving unit 310 receives the molded article item ID selected in the selection field BX1 on the molded article item process association screen SC7 illustrated in FIG. 12 or the molded article item name selected in the selection field BX2 as molded article item information. The step S270 is performed when the OK button BT11 on the molded article item process association screen SC7 is clicked.

In step S280 illustrated in FIG. 9, the fifth receiving unit 350 receives the production process information selected in the selection field BX31 on the molded article item process association screen SC7 illustrated in FIG. 12.

In step S290 illustrated in FIG. 9, the second processing unit 301 of the cloud server 300 stores, in the item defect storage unit 380, the molded article item information received by the first receiving unit 310 in step S270 and the production process information received by the fifth receiving unit 350 in step S280 in association with each other. In step S250, the production process information received by the fifth receiving unit 350 in step S230 and the defect classification information received by the second receiving unit 320 in step S240 are stored in the item defect storage unit 380 in association with each other. Therefore, the molded article item information received by the first receiving unit 310 in step S270 and the defect classification information received by the second receiving unit 320 in step S240 are stored in the item defect storage unit 380 in association with each other via the production process information. The defect classification association processing is performed as described above.

Hereinafter, defect input processing according to the second embodiment will be described. In step S130 of the defect input processing illustrated in FIG. 5, the inspection device 230 outputs the defect input screen SC4 that is a screen for enabling the user to select defect classification information to the inspection device display unit 232. In the second embodiment, the selection field BX11 on the defect input screen SC4 illustrated in FIG. 7 is configured to display a list of defect classification information stored in the item defect storage unit 380 in association with production process information of a molded article item when the user clicks the selection field BX11. Here, the production process information of a molded article item is production process information stored in the item defect storage unit 380 in association with the molded article item information displayed on the defect input screen SC4.

According to the molding management system 10 in the second embodiment described above, the item defect storage unit 380 stores the production process information received by the fifth receiving unit 350 and the defect classification information received by the second receiving unit 320 in association with each other, and stores the molded article item information received by the first receiving unit 310 and the production process information received by the fifth receiving unit 350 in association with each other. That is, the item defect storage unit 380 stores the molded article item information received by the first receiving unit 310 and the defect classification information received by the second receiving unit 320 in association with each other via the production process information. Therefore, even when the molded article item information and the defect classification information are not stored in the item defect storage unit 380 in direct association with each other, the molded article item information and the defect classification information can be stored in the item defect storage unit 380 in indirect association with each other via the production process information.

### C. Other Embodiments

(C-1) In the embodiments described above, the molding management system 10 includes the fourth receiving unit 340. On the other hand, the molding management system 10 may not include the fourth receiving unit 340. In this case, the molded article item storage unit 360 may not store the molded article type information. The item defect storage unit 380 may not store the molded article type information.

(C-2) In the second embodiment, the molded article item information received by the first receiving unit 310 and the defect classification information received by the second receiving unit 320 are stored in the item defect storage unit 380 in association with each other via the production process information. On the other hand, the molded article item information and the defect classification information may be stored in the item defect storage unit 380 in association with each other via not only the production process information but also via other kinds of information. For example, the molded article item information and the defect classification information may be stored in association with each other via the production process information and process order information. Here, the process order information is information related to an order in which each production process is performed. In this case, the molded article item information and the process order information, the process order information and the production process information, and the production process information and the defect classification information are stored in the item defect storage unit 380 in association with each other.

(C-3) In the embodiments described above, the user checks an image of a molded article and determines whether the molded article is a defective article in the defect input processing illustrated in FIG. 5. On the other hand, the inspection device 230 may determine whether the molded article is a defective article. For example, a threshold of a dimension of a specific portion of a molded article may be stored in the inspection device 230 in advance, and the inspection device 230 may determine that the molded article is a defective article when a measured value of the dimension of the specific portion of the molded article exceeds the threshold.

(C-4) In the embodiments described above, the second processing unit 301 of the cloud server 300 generates data of a screen such as the molded article item list screen SC1, the defect classification association screen SC2, and the production process list screen SC5, and outputs the data to the terminal device 400. On the other hand, the second processing unit 301 may output the data of the screen described above to the injection molding machine 210, the inspection device 230, and the management server 100. In this case, the screen described above is displayed on a display device provided in the injection molding machine 210 or the management server 100, or is displayed on the inspection device display unit 232.

(C-5) In the embodiments described above, the second processing unit 301 of the cloud server 300 includes the first receiving unit 310, the second receiving unit 320, the third receiving unit 330, the fourth receiving unit 340, and the fifth receiving unit 350. On the other hand, the first processing unit 101 of the management server 100 may include some or all of the first receiving unit 310, the second receiving unit 320, the third receiving unit 330, the fourth receiving unit 340, and the fifth receiving unit 350.

(C-6) In the embodiments described above, the second storage unit 302 of the cloud server 300 includes the molded article item storage unit 360, the defect classification storage unit 370, the item defect storage unit 380, and the production process storage unit 390. On the other hand, the first storage unit 102 of the management server 100 may include the molded article item storage unit 360, the defect classification storage unit 370, the item defect storage unit 380, and the production process storage unit 390.

### D. Other Aspects

The present disclosure is not limited to the embodiments described above, and can be implemented in various aspects without departing from the spirit of the present disclosure. For example, the present disclosure can be implemented in the following aspects. In order to solve a part of or all of problems of the present disclosure, or to achieve a part of or all of effects of the present disclosure, technical features of the embodiments described above corresponding to technical features in the following aspects can be replaced or combined as appropriate. The technical features can be deleted as appropriate unless described as being essential in the specification.

(1) According to an aspect of the present disclosure, a molding management system is provided. The molding management system includes: a molded article item storage unit configured to store a plurality of pieces of molded article item information that are identification information of an item of a molded article; a defect classification storage unit configured to store master data including a plurality of pieces of defect classification information that are information related to classification of a defect of the molded article; a first receiving unit configured to receive selection of the molded article item information stored in the molded article item storage unit; a second receiving unit configured to receive selection of the defect classification information provided in the master data; an item defect storage unit configured to store the molded article item information received by the first receiving unit and the defect classification information received by the second receiving unit in association with each other; and a third receiving unit configured to receive, when the defect occurs in the molded article, selection of the defect classification information stored in the item defect storage unit in association with the molded article item information of an item of the molded article in which the defect occurs.

According to this aspect, when a defect occurs in a molded article, a user does not need to input detailed information of the occurred defect using a keyboard or the like, and thus it is possible to shorten a time taken to input the detailed information of the defect.

(2) In the above aspect, the molding management system may further include a fourth receiving unit, the molded article item storage unit may store molded article type information that is information related to a type of the molded article and includes any one of an optical component, an insert component, and a multicolor molded component, the fourth receiving unit may receive selection of the molded article type information stored in the molded article item storage unit, and the item defect storage unit may store the molded article item information received by the first receiving unit, the defect classification information received by the second receiving unit, and the molded article type information received by the fourth receiving unit in association with one another.

According to this aspect, a user can select the molded article type information.

(3) In the above aspect, the molded article item information received by the first receiving unit and the defect classification information received by the second receiving unit may be stored in the item defect storage unit in association with each other via production process information that is identification information of a production process of the molded article.

According to this aspect, even when the molded article item information and the defect classification information are not stored in the item defect storage unit in direct association with each other, the molded article item information and the defect classification information can be stored in the item defect storage unit in indirection association with each other via the production process information.

What is claimed is:

1. A molding management system comprising:
a molded article item storage unit configured to store a plurality of pieces of molded article item information that are identification information of an item of a molded article;
a defect classification storage unit configured to store master data including a plurality of pieces of defect classification information that are information related to classification of a defect of the molded article;
a first receiving unit configured to receive selection of the molded article item information stored in the molded article item storage unit;
a second receiving unit configured to receive selection of the defect classification information provided in the master data;
an item defect storage unit configured to store the molded article item information received by the first receiving unit and the defect classification information received by the second receiving unit in association with each other; and
a third receiving unit configured to receive, when the defect occurs in the molded article, selection of the defect classification information stored in the item defect storage unit in association with the molded article item information of an item of the molded article in which the defect occurs.

2. The molding management system according to claim 1, further comprising:
a fourth receiving unit, wherein
the molded article item storage unit stores molded article type information that is information related to a type of the molded article and includes any one of an optical component, an insert component, and a multicolor molded component,
the fourth receiving unit receives selection of the molded article type information stored in the molded article item storage unit, and
the item defect storage unit stores the molded article item information received by the first receiving unit, the defect classification information received by the second receiving unit, and the molded article type information received by the fourth receiving unit in association with one another.

3. The molding management system according to claim 1, wherein
the molded article item information received by the first receiving unit and the defect classification information received by the second receiving unit are stored in the item defect storage unit in association with each other via production process information that is identification information of a production process of the molded article.
